(19) United States
(12) Patent Application Publication
(10) Pub. No.: US 2018/0022332 A1
(43) Pub. Date: Jan. 25, 2018

(54) Brake Apparatus

(71) Applicant: Hitachi Automotive Systems, Ltd., Hitachinaka-shi, Ibaraki (JP)

(72) Inventors: Hiroki SONODA, Atsugi-shi, Kanagawa (JP); Toshiya OOSAWA, Yokohama-shi, Kanagawa (JP); Asahi WATANABE, Kawasaki-shi, Kanagawa (JP)

(21) Appl. No.: 15/549,754

(22) PCT Filed: Feb. 9, 2016
(86) PCT No.: PCT/JP2016/053607

§ 371 Date: Aug. 9, 2017

(30) Foreign Application Priority Data
Feb. 17, 2015 (JP) 2015-028366

(51) Int. Cl. B60T 8/40; B60T 8/88; B60T 8/36; B60T 7/04

(52) U.S. Cl. CPC B60T 8/4081; B60T 7/042; B60T 8/885; B60T 8/363; B60T 8/3655; B60T 2220/04; B60T 2270/82; B60T 2270/404

(57) ABSTRACT

An object of the present invention is to provide a brake apparatus capable of acquiring a sufficient braking force when an abnormality has occurred. The brake apparatus includes a stroke simulator. The stroke simulator is connected to a portion of an oil passage between a master cylinder and a valve. The oil passage connects the master cylinder and a wheel cylinder therebetween. The stroke simulator is configured to generate a brake operation reaction force due to an increase and a reduction in a volume of a positive pressure chamber formed inside the stroke simulator. Brake fluid contained in a first chamber of the master cylinder flows into the positive pressure chamber at the time of control by a by-wire control unit. A fluid amount that can be supplied from the first chamber is larger than a fluid amount that the positive pressure can absorb therein.

### TECHNICAL FIELD

The present invention relates to a brake apparatus mounted on a vehicle.

### BACKGROUND ART

Conventionally, there has been known a brake apparatus including a stroke simulator for creating an operation reaction force accompanying a brake operation performed by a driver, and capable of generating a hydraulic pressure in a wheel cylinder with use of a hydraulic source provided separately from a master cylinder. For example, a brake apparatus discussed in PTL 1 establishes communication between the master cylinder and the wheel cylinder, thereby allowing the hydraulic pressure to be generated in the wheel cylinder by a brake operation force input by the driver, when an abnormality has occurred.

### CITATION LIST

### Patent Literature

PTL 1: Japanese Patent Application Public Disclosure No. 2010-83411

### SUMMARY OF INVENTION

### Technical Problem

However, if the abnormality has occurred with the driver performing the brake operation, this brake apparatus may be unable to acquire a sufficient braking force by the brake operation force input by the driver.

Therefore, an object of the present invention is to provide a brake apparatus capable of acquiring the sufficient braking force when the abnormality has occurred.

### Solution to Problem

To achieve the above-described object, a brake apparatus according to the present invention is configured in such a manner that a fluid amount that can be supplied from a master cylinder is larger than a fluid amount that a stroke simulator can absorb therein.

### BRIEF DESCRIPTION OF DRAWINGS

FIG. 1 schematically illustrates a configuration of a brake apparatus according to a first embodiment.

FIG. 2 schematically illustrates a configuration of a master cylinder according to the first embodiment.

FIG. 3 illustrates a relationship between a brake pedal maximum stroke amount S* and a secondary piston required stroke amount Ls* with respect to a pedal ratio K according to the first embodiment.

FIG. 4 is a timing chart when a failure has occurred during by-wire control according to the first embodiment.

FIG. 5 is a timing chart when the failure has occurred during the by-wire control according to a comparative example.

### DESCRIPTION OF EMBODIMENTS

In the following description, embodiments for realizing a brake apparatus according to the present invention will be described based on an exemplary embodiment illustrated in the drawings.

### First Embodiment

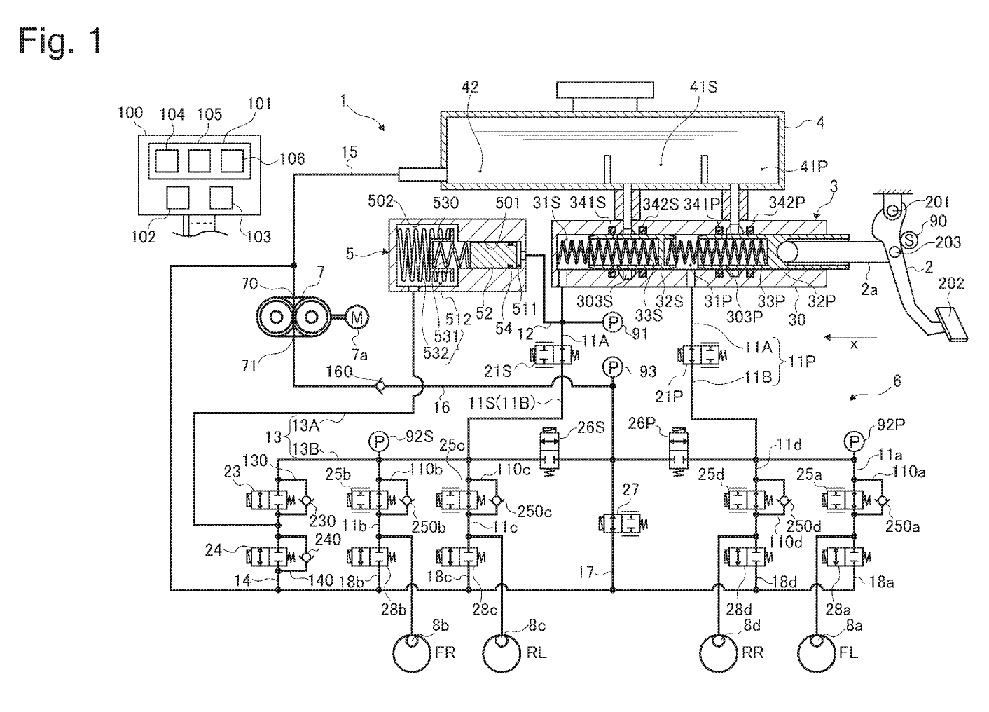

First, a configuration will be described. FIG. 1 schematically illustrates a configuration including a hydraulic circuit regarding a brake apparatus 1 (a brake system) according to a first embodiment. The brake apparatus 1 (hereinafter referred to as the apparatus 1) is a hydraulic brake apparatus preferably usable for an electric vehicle. The electric vehicle is, for example, a hybrid automobile including a motor generator (a rotational electric machine) besides an engine (an internal combustion engine) or an electric automobile including only the motor generator, as a prime mover for driving wheels. The apparatus 1 may also be applied to a vehicle using only the engine as the driving force source. The apparatus 1 supplies brake fluid into a wheel cylinder 8 mounted on each of wheels FL, FR, RL, and RR of the vehicle to generate a brake hydraulic pressure (a wheel cylinder pressure Pw). The apparatus 1 displaces a frictional member by this Pw to press the friction member against a rotational member on a wheel side, thereby generating a frictional force. By this frictional force, the apparatus 1 applies a hydraulic braking force to each of the wheels FL, FR, RL, and RR. Then, the wheel cylinder 8 may be a wheel cylinder in a drum brake mechanism, or a cylinder of a hydraulic brake caliper in a disk brake mechanism. The apparatus 1 includes two brake pipe systems, i.e., a P (primary) system and an S (secondary) system, and employs, for example, an X-split pipe configuration. The apparatus 1 may employ another pipe configuration, such as a front/rear split pipe configuration. Hereinafter, when a member provided in correspondence with the P system and a member provided in correspondence with the S system should be distinguished from each other, indices P and S will be added at the ends of the respective reference numerals.

A brake pedal 2 is a brake operation member that receives an input of a brake operation from an operator (a driver). The brake pedal 2 is a so-called suspended-type brake pedal, and a proximal end thereof is rotatably supported by a shaft 201. A pad 202, which serves as a target that the driver presses, is provided at a distal end of the brake pedal 2. One end of a push rod 2a is connected rotatably by a shaft 203 at a proximal side of the brake pedal 2 between the shaft 201 and the pad 202.

A master cylinder 3 generates a brake hydraulic pressure (a master cylinder pressure Pm) by being activated by an operation performed on the brake pedal 2 by the driver (the brake operation). The apparatus 1 does not include a negative-pressure booster that boosts or amplifies a brake operation force (a force F pressing the brake pedal 2) by utilizing an intake negative pressure generated by the engine of the vehicle. Therefore, the apparatus 1 can be reduced in size. The master cylinder 3 is connected to the brake pedal 2 via the push rod 2a, and is also replenished with the brake fluid from a reservoir tank (a reservoir) 4. The reservoir tank 4 is a brake fluid source that stores the brake fluid therein, and is a low-pressure portion opened to an atmospheric pressure. A bottom side (a vertically lower side) inside the reservoir tank 4 is partitioned (divided) into a primary hydraulic chamber space 41P, a secondary hydraulic chamber space 41S, and a pump intake space 42 by a plurality of partition members each having a predetermined height. The master cylinder 3 is a tandem-type master cylinder, and includes a primary piston 32P and a secondary piston 32S in series, as master cylinder pistons axially displaceable according to the brake operation. The primary piston 32P is connected to the push rod 2a. The secondary piston 32S is configured as a free piston.

A stroke sensor 90 is provided at the brake pedal 2. The stroke sensor 90 detects an amount of a displacement of the brake pedal 2 (a pedal stroke S). The apparatus 1 may be configured to detect S by including the stroke sensor 90 at the push rod 2a or the primary piston 32P. S corresponds to a value acquired by multiplying an amount of an axial displacement of the push rod 2a or the primary piston 32P (a stroke amount) by a pedal ratio K of the brake pedal. K is a ratio of S to the stroke amount of the primary piston 32P, and is set to a predetermined value. K can be calculated based on, for example, a ratio of a distance from the shaft 201 to the pad 202 to a distance from the shaft 201 to the shaft 203.

The stroke simulator 5 is activated in response to the brake operation performed by the driver. The stroke simulator 5 generates the pedal stroke S by an inflow of the brake fluid transmitted out from inside the master cylinder 3 according to the brake operation performed by the driver into the stroke simulator 5. A piston 52 of the stroke simulator 5 is activated axially in the cylinder 50 by the brake fluid supplied from the master cylinder 3. By this operation, the stroke simulator 5 generates an operation reaction force accompanying the brake operation performed by the driver.

A hydraulic control unit 6 is a braking control unit capable of generating the brake hydraulic pressure independently of the brake operation performed by the driver. An electronic control unit (hereinafter referred to as an ECU) 100 is a control unit that controls activation of the hydraulic control unit 6. The hydraulic control unit 6 receives supply of the brake fluid from the reservoir tank 4 or the master cylinder 3. The hydraulic control unit 6 is provided between the wheel cylinders 8 and the master cylinder 3, and can supply the master cylinder pressure Pm or a control hydraulic pressure to each of the wheel cylinders 8 individually. The hydraulic control unit 6 includes a motor 7a of a pump 7 and a plurality of control valves (electromagnetic valves 21 and the like) as hydraulic devices (actuators) for generating the control hydraulic pressure. The pump 7 introduces the brake fluid therein from a brake fluid source (the reservoir tank 4 or the like) other than the master cylinder 3, and discharges the brake fluid toward the wheel cylinders 8. In the present embodiment, the pump 7 is embodied with use of a gear pump excellent in terms of a noise and vibration performance and the like, in particular, an external gear-type pump unit. The pump 7 may be embodied with use of a plunger pump or the like. The pump 7 is used in common by both the systems, and is rotationally driven by the electric motor (a rotational electric machine) 7a as a common driving source. The motor 7a can be embodied with use of, for example, a brushed motor. A resolver is provided at an output shaft of the motor 7a. The resolver detects a rotational position (a rotational angle) thereof. The electromagnetic valves 21 and the like are each opened and closed according to a control signal to switch a communication state of oil passages 11 or the like. By this operation, the hydraulic control unit 6 controls a flow of the brake fluid. The hydraulic control unit 6 is provided so as to be able to increase the pressures in the wheel cylinders 8 with use of the hydraulic pressure generated by the pump 7 with the master cylinder 3 and the wheel cylinders 8 out of communication with each other. Further, the hydraulic control unit 6 includes hydraulic sensors 91 to 93, which detect hydraulic pressures at various locations such as a pressure discharged from the pump 7 and Pm.

Information input to the ECU 100 includes detected values transmitted from the resolver, the stroke sensor 90, and the hydraulic sensors 91 to 93, and information regarding a running state transmitted from the vehicle side. The ECU 100 engages in information processing based on these various kinds of information according to a program installed therein. Further, the ECU 100 outputs an instruction signal to each of the actuators in the hydraulic control unit 6 according to a result of this processing, thereby controlling them. More specifically, the ECU 100 controls opening/closing operations of the electromagnetic valves 21 and the like, and the number of times that the motor 7a rotates (i.e., an amount discharged from the pump 7). By this control, the ECU 100 controls the wheel cylinder pressure Pw at each of the wheels FL, FR, RL, and RR, thereby realizes various kinds of brake control. For example, the ECU 100 realizes boosting control, anti-lock control, brake control for vehicle motion control, automatic brake control, regenerative cooperative brake control, and the like. The boosting control assists the brake operation by generating a hydraulic braking force by which the brake operation force input by the driver is insufficient. The anti-lock control prevents or reduces a slip (a lock tendency) of any of the wheels FL, FR, RL, and RR that is caused from the braking. The vehicle motion control is electronic stability control (hereinafter referred to as ESC) for preventing a sideslip and the like. The automatic brake control is adaptive cruise control or the like. The regenerative cooperative brake control controls Pw so as to achieve a target deceleration (a target braking force) by collaborating with the regenerative brake.

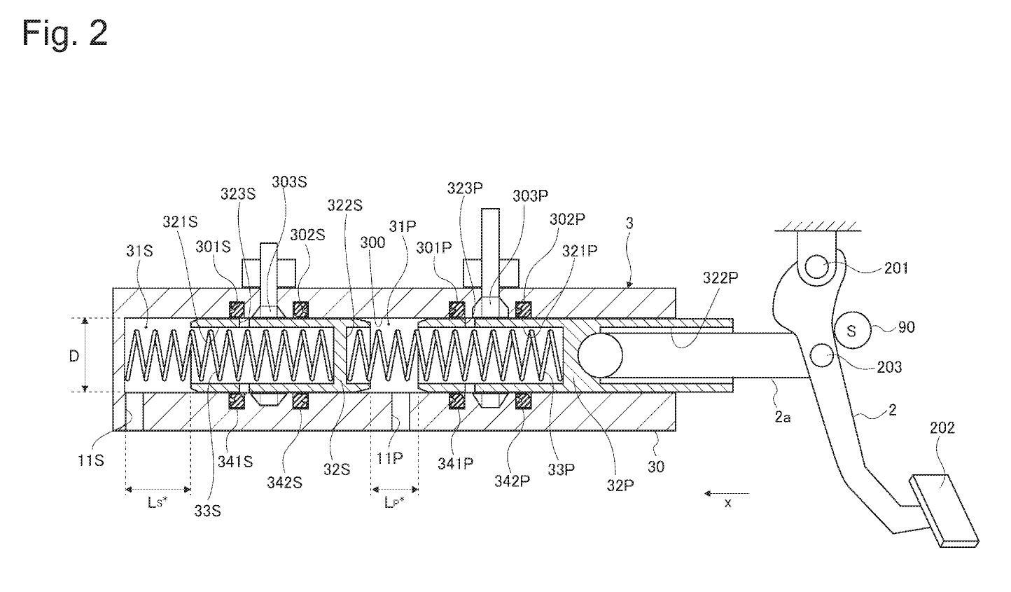

FIG. 2 is a cross-sectional view taken along a central axis of a cylinder 30 of the master cylinder 3, and schematically illustrates a configuration of the master cylinder 3. Hereinafter, an x axis is set to a direction in which the central axis of the cylinder 30 extends for convenience of the description. Assume that a positive side in a x-axis direction is one side where the secondary piston 32S is positioned with respect to the primary piston 32P. The master cylinder 3 is connected to the wheel cylinders 8 via the first oil passages 11, which will be described below. The master cylinder 3 is a first hydraulic source capable of generating the hydraulic pressures Pw in the wheel cylinders 8 by generating hydraulic pressures in the first oil passages 11 with use of the brake fluid supplied from the reservoir tank 4. The cylinder 30 has a bottomed cylindrical shape, and includes a cylindrical inner peripheral surface 300. Seal grooves 301 and 302, and a replenishment port 303 are provided on the inner peripheral surface 300 for each of the P and S systems. The seal grooves 301 and 302 extend in a direction around the central axis of the cylinder 30 (a circumferential direction). The first seal groove 301 is provided on the positive side in the x-axis direction with respect to the second seal groove 302. The replenishment port 303 extending in the circumferential direction is provided so as to be sandwiched between the two seal grooves 301 and 302. The replenishment port 301 is connected to the reservoir tank 4 and is in communication therewith. The replenishment port 303P is connected to the primary hydraulic chamber space 41P, and the replenishment port 303S is connected to the secondary hydraulic chamber space 41S.

The pistons 32 of the master cylinder 3 are inserted inside the cylinder 30 displaceably in the x-axis direction along the inner peripheral surface 300 thereof. Diameters of the pistons 32 are slightly smaller than a diameter of the cylinder 30 (the inner peripheral surface 300). The two pistons 32P and 32S have diameters and cross-sectional areas equal to each other. Now, the cross-sectional area refers to an area of a cross-section taken along a plane perpendicular to the x axis (a central axis of each of the pistons 32). Assume that D represents the diameter of each of the two pistons 32P and 32S. Assume that A represents the cross-sectional area of each of the two pistons 32P and 32S. A can be calculated from D. D can be regarded as being equal to the diameter of the master cylinder 3 (the cylinder 30). A can be regarded as being equal to a cross-sectional area of the master cylinder 3 (the cylinder 30). Each of the pistons 32 includes recessed portions 321 and 322 extending in the x-axis direction. The recessed portion 321 is opened to a positive side of the piston 32 in the x-axis direction. The recessed portion 322 is opened to a negative side of the piston 32 in the x-axis direction. An oil hole 323 is formed radially through the piston 32 on the positive side of the each of the pistons 32 in the x-axis direction so as to establish communication between an inner peripheral surface of the recessed portion 321 and an outer peripheral surface of the piston 32. Focusing on the primary piston 32P, a negative side of a coil spring 33P as a return spring in the x-axis direction is set in the recessed portion 321P. A positive side of the push rod 2a in the x-axis direction is set in the recessed portion 322P. Focusing on the secondary piston 32S, a negative side of a coil spring 33S as a return spring in the x-axis direction is set in the recessed portion 321S. A positive side of the coil spring 33P in the x-axis direction is set in the recessed portion 322S.

A primary hydraulic chamber 31P is defined between the two pistons 32P and 32S. The coil spring 33P is set in the primary hydraulic chamber 31P in a pressed and compressed state. A secondary hydraulic chamber 31S is defined between the piston 32S and an end of the cylinder 30 on the positive side in the x-axis direction. The coil spring 33S is set in the secondary hydraulic chamber 31S in a pressed and compressed state. The first oil passage 11 is opened to each of the hydraulic chambers 31P and 31S. The first oil passage 11 is constantly opened to the hydraulic chamber 31, without being blocked by the outer peripheral surface of the piston 32, within a range where the piston 32 is displaceable in the x-axis direction relative to the cylinder 30. Each of the hydraulic chambers 31P and 31S is provided so as to be connectable to the hydraulic control unit 6 and communicable with the wheel cylinders 8, via the first oil passage 11.

Piston seals 34 (corresponding to 341 and 342 in the drawing) are placed in the seal grooves 301 and 302. The piston seals 34 seal between the outer peripheral surfaces of the individual pistons 32P and 32S and the inner peripheral surface 300 of the cylinder 30 while being in sliding contact with the individual pistons 32P and 32S (moving while contacting the individual pistons 32P and 32S). Each of the piston seals 34 is a known seal member cup-shaped in cross-section (a cup seal) that includes a lip portion on a radially inner side. The piston seal 34 permits a flow of the brake fluid in one direction, and prohibits or reduces a flow of the brake fluid in the other direction. Communication between the replenish port 301 and the hydraulic chamber 31 via the oil hole 323 is blocked in such a state that an opening portion of the oil hole 323 on the outer peripheral surface of the piston 32 is located on the positive side in the x-axis direction with respect to the first piston seal 341 (the lip portion thereof). The first piston seal 341 permits a flow of the brake fluid heading from the replenishment port 303 toward the hydraulic chamber 31, and prohibits or reduces a flow of the brake fluid in an opposite direction, between the inner peripheral surface 300 of the cylinder 30 and the outer peripheral surface of the piston 32. The second piston seal 342P prohibits or reduces a flow of the brake fluid heading from the replenishment port 303P toward the brake pedal 2 side. The second piston seal 342S prohibits or reduces a flow of the brake fluid heading from the primary hydraulic chamber 31P toward the replenishment port 303S.

When each of the pistons 32 is stroked toward the positive side in the x-axis direction by the driver's operation of pressing the brake pedal 2 to cause the above-described opening portion of the oil hole 323 to be located on the positive side in the x-axis direction with respect to the first piston seal 314 (the lip portion thereof), the hydraulic pressure Pm is generated therein according to a reduction in the volume of the hydraulic chamber 31. Approximately equal hydraulic pressures Pm are generated in the two hydraulic chambers 31P and 31S. As a result, the brake fluid is supplied from the hydraulic chamber 31 toward the wheel cylinders 8 via the first oil passages 11. An amount of the stroke of the piston 32 from an initial position that is required until the hydraulic chamber 31 starts generating Pm after the oil passage 323 passes through the first piston seal 341 (the lip portion thereof) is slight and can be regarded as zero. The master cylinder 3 can increase the pressures in the wheel cylinders 8a and 8d of the P system via the oil passage (the first oil passage 11P) of the P system with use of Pm generated in the primary hydraulic chamber 31P. Further, the master cylinder 3 can increase the pressures in the wheel cylinders 8b and 8c of the S system via the oil passage (the first oil passage 11S) of the S system with use of Pm generated in the secondary hydraulic chamber 31S.

Next, a configuration of the stroke simulator 5 will be described with reference to FIG. 1. The stroke simulator 5 includes a cylinder 50, the piston 52, and a spring 53. FIG. 1 illustrates a cross-section taken along a central axis of the cylinder 50 of the stroke simulator 5. The cylinder 50 is cylindrical, and has a cylindrical inner peripheral surface. The cylinder 50 includes a piston containing portion 501 relatively small in diameter on the negative side in the x-axis direction, and a spring containing portion 502 relatively large in diameter on the positive side in the x-axis direction. A third oil passage 13 (13A), which will be described below, is constantly opened on an inner peripheral surface of the spring containing portion 502. The piston 52 is installed on an inner peripheral side of the piston containing portion 501 displaceably in the x-axis direction along an inner peripheral surface thereof. The piston 52 is a separation member (a partition wall) separating the inside of the cylinder 50 into at least two chambers (a positive pressure chamber 511 and a backpressure chamber 512). The positive pressure chamber 511 and the backpressure chamber 512 are defined on a negative side and a positive side of the piston 52 in the x-axis direction, respectively, inside the cylinder 50. The positive pressure chamber 511 is a space surrounded by a surface of the piston 52 on the negative side in the x-axis direction and the inner peripheral surface of the cylinder 50 (the piston containing portion 501). The second oil passage 12 is constantly opened to the positive pressure chamber 511. The backpressure chamber 512 is a space surrounded by a surface of the piston 52 on the positive side in the x-axis direction and the inner peripheral surface of the cylinder 50 (the spring containing portion 502 and the piston containing portion 501). The oil passage 13A is constantly opened to the backpressure chamber 512.

A piston seal 54 is placed on an outer periphery of the piston 52 so as to extend in a direction around a central axis of the piston 52 (a circumferential direction). The piston seal 54 is in sliding contact with the inner peripheral surface of the cylinder 50 (the piston containing portion 501), and seals between the inner peripheral surface of the piston containing portion 501 and the outer peripheral surface of the piston 52. The piston seal 54 is a separation seal member that seals between the positive pressure chamber 511 and the backpressure chamber 512 to thereby liquid-tightly separate them, and complements the function of the piston 52 as the above-described separation member. The spring 53 is a coil spring (an elastic member) placed in the backpressure chamber 512 in a pressed and compressed state, and constantly biases the piston 52 toward the negative side in the x-axis direction. The spring 53 is provided deformably in the x-axis direction, and can generate the reaction force according to the displacement amount (the stroke amount) of the piston 52. The spring 53 includes a first spring 531 and a second spring 532. The first spring 531 is shorter in diameter and dimension than the second spring 532, and has a short wire diameter. A spring constant of the first spring 531 is smaller than that of the second spring 532. The first and second springs 531 and 532 are disposed in series between the piston 52 and the cylinder 50 (the spring containing portion 502) via a retainer member 530.

Next, a hydraulic circuit of the hydraulic control unit 6 will be described with reference to FIG. 1. Members corresponding to the individual wheels FL, FR, RL, and RR will be distinguished from one another if necessary, by indices a to d added at the ends of reference numerals thereof, respectively. The first oil passages 11 connect the hydraulic chambers 31 of the master cylinder 3 and the wheel cylinders 8 to each other. A shut-off valve (a master cutoff valve) 21 is a normally-opened (opened when no power is supplied) electromagnetic valve provided in each of the first oil passages 11. Each of the first oil passages 11 is divided into an oil passage 11A on a master cylinder 3 side and an oil passage 11B on a wheel cylinder 8 side by the shut-off valve 21. A solenoid IN valve (a pressure increase valve) SOL/V IN 25 is a normally-opened electromagnetic valve provided in correspondence with each of the wheels FL, FR, RL, and RR (in each of oil passages 11a to 11d) on the wheel cylinder 8 side (the oil passage 11B) with respect to the shut-off valve 21 in each of the first oil passages 11. Bypass oil passages 110 is provided in parallel with each of the first oil passages 11 while bypassing the SOL/V IN 25. A check valve (a one-way valve or a non-return valve) 250 is provided in each of the bypass oil passages 110. The check valve 250 permits only a flow of the brake fluid from the wheel cylinder 8 side to the master cylinder 3 side.

An intake oil passage 15 is an oil passage connecting the reservoir tank 4 (the pump intake space 42) and an intake portion 70 of the pump 7. A discharge oil passage 16 connects a discharge portion 71 of the pump 7 and a portion in the first oil passage 11B between the shut-off valve 21 and the SOL/V IN 25. A check valve 160 is provided in the discharge oil passage 16, and permits only a flow from one side where the discharge portion 71 of the pump 7 is located (an upstream side) to the other side where the first oil passage 11 is located (a downstream side). The check valve 160 is a discharge valve provided to the pump 7. The discharge oil passage 16 branches into an oil passage 16P of the P system and an oil passage 16S of the S system on the downstream side of the check valve 160. The individual oil passages 16P and 16S are connected to the first oil passage 11P of the P system and the first oil passage 11S of the S system, respectively. The oil passages 16P and 16S function as a communication passage connecting the first oil passages 11P and 11S to each other. A communication valve 26P is a normally-closed (closed when no power is supplied) electromagnetic valve provided in the oil passage 16P. A communication valve 26S is a normally-closed electromagnetic valve provided in the oil passage 16S. The pump 7 is a second hydraulic source capable of generating the hydraulic pressures Pw in the wheel cylinders 8 by generating the hydraulic pressures in the first oil passages 11 with use of the brake fluid supplied from the reservoir tank 4. The pump 7 is connected to the wheel cylinders 8a to 8d via the above-described communication passages (the discharge oil passages 16P and 16S) and the first oil passages 11P and 11S, and can increase the pressures in the wheel cylinders 8 by discharging the brake fluid to the above-described communication passages (the discharge oil passages 16P and 16S).

A first pressure reduction oil passage 17 connects a portion in the discharge oil passage 16 between the check valve 160 and the communication valve 26, and the intake oil passage 15 to each other. A pressure adjustment valve 27 is a normally-opened electromagnetic valve as a first pressure reduction valve provided in the first pressure reduction oil passage 17. Second pressure reduction oil passages 18 connect the wheel cylinder 8 side of the first oil passages 11B with respect to the SOL/INs 25, and the intake oil passage 15 to each other. A solenoid OUT valve (a pressure reduction valve) SOL/V OUT 28 is a normally-closed electromagnetic valve as a second pressure reduction valve provided in each of the second pressure reduction oil passages 18. In the present embodiment, the first pressure reduction oil passage 17 on one side closer to the intake oil passage 15 with respect to the pressure adjustment valve 27, and the second pressure reduction oil passage 18 on one side closer to the intake oil passage 15 with respect to the SOL/V OUT 28 share a part thereof with each other.

The second oil passage 12 is a branch oil passage that branches off from the first oil passage 11B to be connected to the stroke simulator 5. The second oil passage 12 functions as a positive-pressure side oil passage connecting the secondary hydraulic chamber 31S of the master cylinder 3 and the positive pressure chamber 511 of the stroke simulator 5 to each other, together with the first oil passage 11B. The hydraulic control unit 6 may be configured in such a manner that the second oil passage 12 directly connects the secondary hydraulic chamber 31S and the positive pressure chamber 511 to each other without the intervention of the first oil passage 11B. The third oil passage 13 is a first backpressure-side oil passage connecting the backpressure chamber 512 of the stroke simulator 5 and the first oil passage 11. More specifically, the third oil passage 13 branches off from a portion in the first oil passage 11S (the oil passage 11B) between the shut-off valve 21S and the SOL/V IN 25, and is connected to the backpressure chamber 512. A stroke simulator IN valve SS/V IN 23 is a normally-closed electromagnetic valve provided in the third oil passage 13. The third oil passage 13 is divided into an oil passage 13A on the backpressure chamber 512 side and an oil passage 13B on the first oil passage 11 side by the SS/V IN 23. A bypass oil passage 130 is provided in parallel with the third oil passage 13 while bypassing the SS/V IN 23. The bypass oil passage 130 connects the oil passage 13A and the oil passage 13B to each other. A check valve 230 is provided in the bypass oil passage 130. The check valve 230 permits a flow of the brake fluid heading from the backpressure chamber 512 side (the oil passage 13A) toward the first oil passage 11 side (the oil passage 13B), and prohibits or reduces a flow of the brake fluid in an opposite direction.

A fourth oil passage 14 is a second backpressure-side oil passage connecting the backpressure chamber 512 of the stroke simulator 5 and the reservoir tank 4 to each other. The fourth oil passage 14 connects a portion (the oil passage 13A) in the third oil passage 13 between the backpressure chamber 512 and the SS/V IN 23, and the intake oil passage 15 (or the first pressure reduction oil passage 17 on the intake oil passage 15 side with respect to the pressure adjustment valve 27 and the second pressure reduction oil passages 18 on the intake oil passage 15 side with respect to the SOL/V OUTs 28). The hydraulic control unit 6 may be configured in such a manner that the fourth oil passage 14 is directly connected to the backpressure chamber 512 or the reservoir tank 4. A stroke simulator OUT valve (a simulator cutoff valve) SS/V OUT 24 is a normally-closed electromagnetic valve provided in the fourth oil passage 14. A bypass oil passage 140 is provided in parallel with the fourth oil passage 14 while bypassing the SS/V OUT 24. A check valve 240 is provided in the bypass oil passage 140. The check valve 240 permits a flow of the brake fluid heading from the reservoir tank 4 (the intake oil passage 15) side toward the third oil passage 13A side, i.e., the backpressure chamber 512 side, and prohibits or reduces a flow of the brake fluid in an opposite direction therefrom.

The shut-off valves 21, the SOL/V INs 25, and the pressure adjustment valve 27 are each a proportional control valve, an opening degree of which is adjusted according to a current supplied to a solenoid. The other valves, i.e., the SS/V IN 23, the SS/V OUT 24, the communication valves 26, and the SOL/V OUTs 28 are each a two-position valve (ON/OFF valve), opening/closing of which is controlled to be switched between two values, i.e., switched to be either opened or closed. The above-described other valves can also be embodied with use of the proportional control valve. The hydraulic sensor 91 is provided at a portion (the oil passage 11A) of the first oil passage 11S between the shut-off valve 21S and the master cylinder 3. The hydraulic sensor 91 detects a hydraulic pressure at this portion (the master cylinder pressure Pm and the hydraulic pressure in the positive pressure chamber 511 of the stroke simulator 5). The hydraulic sensor (a primary system pressure sensor or a secondary system pressure sensor) 92 is provided in a portion of each of the first oil passages 11 between the shut-off valve 21 and the SOL/V INs 25. The hydraulic sensor 92 detects a hydraulic pressure at this portion (the wheel cylinder pressure Pw). The hydraulic sensor 93 is provided in a portion of the discharge oil passage 16 between the discharge portion 71 of the pump 7 (the check valve 160) and the communication valves 26. The hydraulic sensor 93 detects a hydraulic pressure at this portion (the pump discharge pressure).

A first system is formed by a brake system (the first oil passages 11) that connects the hydraulic chambers 31 of the master cylinder 3 and the wheel cylinders 8 to each other with the shut-off valves 21 controlled in valve-opening directions. This first system can realize pressing force brake (non-boosting control) by generating the wheel cylinder pressures Pw from the master cylinder pressures Pm generated with use of the pressing force F. On the other hand, a second system is formed by a brake system (the intake oil passage 15, the discharge oil passage 16, and the like) that includes the pump 7 and connects the reservoir tank 4 and the wheel cylinders 8 to each other with the shut-off valves 21 controlled in valve-closing directions. This second system constructs a so-called brake-by-wire device, which generates Pw from the hydraulic pressure generated with use of the pump 7, and can realize the boosting control and the like as brake-by-wire control. At the time of the brake-by-wire control (hereinafter simply referred to as by-wire control), the stroke simulator 5 creates the operation reaction force accompanying the brake operation performed by the driver.

The ECU 100 includes a by-wire control unit 101, a pressing force brake unit 102, and a fail-safe unit 103. The by-wire control unit 101 closes the shut-off valves 21 to increase in the pressures in the wheel cylinders 8 by the pump 7 according to a state of the brake operation performed by the driver. In the following description, specific examples thereof will be described. The by-wire control unit 101 includes a brake operation state detection unit 104, a target wheel cylinder pressure calculation unit 105, and a wheel cylinder pressure control unit 106. The brake operation state detection unit 104 detects the pedal stroke S as a brake operation amount input by the driver upon receiving the input of the value detected by the stroke sensor 90. Further, the brake operation state detection unit 104 detects whether the driver is performing the brake operation (whether the brake pedal 2 is being operated) based on S. A pressing force sensor for detecting the pressing force F may be provided and the brake operation state detection unit 104 may be configured to detect or estimate the brake operation amount based on a value detected thereby. Alternatively, the brake operation state detection unit 104 may be configured to detect or estimate the brake operation amount based on the value detected by the hydraulic sensor 91. In other words, the brake operation state detection unit 104 may use, instead of S, another appropriate variable as the brake operation amount to be used in the control.

The target wheel cylinder pressure calculation unit 105 calculates a target wheel cylinder pressure Pw*. For example, at the time of the boosting control, the target wheel cylinder pressure calculation unit 105 calculates, based on the detected pedal stroke S (the brake operation amount), Pw* that realizes an ideal relationship between S and a brake hydraulic pressure requested by the driver (a vehicle deceleration requested by the driver) according to a predetermined boosting ratio. For example, a predetermined relationship between S and Pw (the braking force) realized when the negative-pressure booster is activated in a brake apparatus including the negative-pressure booster normal in size is set as the above-described ideal relationship for calculating Pw*.

The wheel cylinder pressure control unit 106 controls the shut-off valves 21 in the valve-closing directions, thereby bringing the hydraulic control unit 6 into a state capable of creating Pw with use of the pump 7 (the second system) (pressure increase control). The wheel cylinder pressure control unit 106 controls each of the actuators in the hydraulic control unit 6 in this state, thereby performing hydraulic control (for example, the boosting control) for realizing Pw*. More specifically, the wheel cylinder pressure control unit 106 controls the shut-off valves 21 in the valve-closing directions, the communication valves 26 in valve-opening directions, and the pressure adjustment valve 27 in a valve-closing direction, and also activates the pump 7. Controlling each of the actuators in this manner allows desired brake fluid to be transmitted from the reservoir tank 4 side to the wheel cylinders 8 via the intake oil passage 15, the pump 7, the discharge oil passage 16, and the first oil passages 11. The brake fluid discharged from the pump 7 flows into the first oil passages 11B via the discharge oil passage 16. This brake fluid flows into each of the wheel cylinders 8, thereby increasing the pressure in each of the wheel cylinders 8. In other words, the pressure in each of the wheel cylinders 8 is increased with use of the hydraulic pressure generated in the first oil passage 11B with use of the pump 7. At this time, a desired braking force can be acquired by performing feedback control on the number of times that the pump 7 rotates and a valve-opening state (an opening degree and/or the like) of the pressure adjustment valve 27 so that the value detected by the hydraulic sensor 92 approaches Pw*. In other words, Pw can be adjusted by controlling the valve-opening state of the pressure adjustment valve 27 and allowing the brake fluid to leak from the discharge oil passage 16 or the first oil passages 11 to the intake oil passage 15 via the pressure adjustment valve 27 as appropriate. In the present embodiment, Pw is controlled basically by changing the valve-opening state of the pressure adjustment valve 27 instead of the number of times that the pump 7 (the motor 7a) rotates. Controlling the shut-off valves 21 in the valve-closing directions and blocking the communication between the master cylinder 3 side and the wheel cylinder 8 side facilitates the control of Pw independently of the brake operation performed by the driver.

On the other hand, the SS/V OUT 24 is controlled in a valve-opening direction. As a result, communication is established between the backpressure chamber 512 of the stroke simulator 5 and the intake oil passage 15 (the reservoir tank 4) side. Therefore, when the brake fluid is discharged from the master cylinder 3 according to the operation of pressing the brake pedal 2, and this brake fluid flows into the positive pressure chamber 511 of the stroke simulator 5, the piston 52 is activated. As a result, the pedal stroke S is generated. The brake fluid flows out from the backpressure chamber 512 by a similar fluid amount to the fluid amount flowing into the positive pressure chamber 511. This brake fluid is discharged toward the intake oil passage 15 (the reservoir tank 4) side via the third oil passage 13A and the fourth oil passage 14. The fourth oil passage 14 may be connected to a low pressure portion into which the brake fluid can flow, and does not necessarily have to be connected to the reservoir tank 4. Further, the operation reaction force applied to the brake pedal 2 (the pedal reaction force) is generated due to the force with which the spring 53 of the stroke simulator 5, the hydraulic pressure in the backpressure chamber 512, and the like press the piston 52. In other words, the stroke simulator 5 generates a characteristic of the brake pedal 2 (an F-S characteristic, which is a relationship of S to F) at the time of the by-wire control.

The wheel cylinder pressure control unit 106 basically performs the boosting control at the time of normal brake, in which the braking force is generated on each of the front and rear wheels FL, FR, RL, and RR according to the brake operation performed by the driver. In the boosting control, the wheel cylinder pressure control unit 106 controls the SOL/V IN 25 in a valve-opening direction and the SOL/V OUT 28 in a valve-closing direction for each of the wheel FL, FR, RL, and RR. The wheel cylinder pressure control unit 106 proportionally controls the pressure adjustment valve 27 in the valve-closing direction (performs the feedback control on the opening degree and/or the like) with the shut-off valves 21P and 21S controlled in the valve-closing directions. The wheel cylinder pressure control unit 106 controls the communication valves 26 in the valve-opening directions, and activates the pump 7 while setting an instruction value Nm* for the number of times that the motor 7a rotates to a predetermined constant value. The wheel cylinder pressure control unit 106 deactivates the SS/V IN 23 (controls the SS/V IN 23 in a valve-closing direction) and activates the SS/V OUT (controls the SS/V OUT 24 in the valve-opening direction).

The pressing force brake unit 102 opens the shut-off valves 21, thereby increasing the pressures in the wheel cylinders 8 with use of the master cylinder 3. The pressing force brake unit 102 controls the shut-off valves 21 in the valve-opening directions, thereby bringing the hydraulic control unit 6 into a state capable of generating the wheel cylinder pressures Pw from the master cylinder pressures Pm (the first system), thus realizing the pressing force brake. At this time, the pressing force brake unit 102 controls the SS/V OUT 24 in a valve-closing direction, thereby making the stroke simulator 5 inactive in response to the brake operation performed by the driver. As a result, the brake fluid is efficiently supplied from the master cylinder 3 toward the wheel cylinders 8. Therefore, a reduction in Pw generated by the pressing force F input by the driver can be prevented or cut down. More specifically, the pressing force brake unit 102 deactivates all of the actuators in the hydraulic control unit 6. The pressing force brake unit 102 may be configured to control the SS/V IN 23 in a valve-opening direction.

The fail-safe unit 103 detects occurrence of an abnormality (a failure or a malfunction) in the apparatus 1 (the brake system). For example, the fail-safe unit 103 detects a failure in the actuator (the pump 7, the motor 7a, the pressure adjustment valve 27, or the like) in the hydraulic control unit 6 based on the signal from the brake operation state detection unit 104 and the signal from each of the sensors. Alternatively, the fail-safe unit 103 detects an abnormality in an in-vehicle power source (a battery) supplying power to the apparatus 1, or the ECU 100. Upon detecting the occurrence of the abnormality during the by-wire control, the fail-safe unit 103 activates the pressing force brake unit 102, thereby switching the brake control from the by-wire control to the pressing-force brake. More specifically, the fail-safe unit 103 deactivates all of the actuators in the hydraulic control unit 6, thereby causing the apparatus 1 to transition to the pressing force brake. The shut-off valves 21 are the normally-opened valves. Therefore, when the power failure has occurred, the apparatus 1 can automatically realize the pressing force brake by allowing the shut-off valves 21 to be opened. The SS/V OUT 24 is the normally-closed valve. Therefore, when the power failure has occurred, the apparatus 1 automatically makes the stroke simulator 5 inactive by allowing the SS/V OUT 24 to be closed. The communication valves 26 are the normally-closed valves. Therefore, when the power failure has occurred, the apparatus 1 allows the brake hydraulic systems of the two systems to operate independently of each other, allowing the systems to increase separately from each other the pressures in the wheel cylinders based on the pressing force F. Due to this configuration, the apparatus 1 can improve a fail-safe performance.

Next, settings of various dimensions of the brake pedal 2, the master cylinder 3, and the stroke simulator 5 will be described. Assume that Vp* represents a brake fluid amount that can be stored in the primary hydraulic chamber 31P, i.e., a fluid amount that can be supplied (can flow out) from the primary hydraulic chamber 31P. Assume that Lp represents a stroke amount of the primary piston 32P relative to the secondary piston 32S. Assume that Lp* represents Lp required to achieve a primary piston required stroke amount, i.e., Vp*. More specifically, Lp* is a maximum stroke amount of the primary piston 32P (relative to the secondary piston 32S). Assume that Vs* represents a brake fluid amount that can be stored in the secondary hydraulic chamber 31S, i.e., an amount of the brake fluid that can be supplied (can flow out) from the secondary hydraulic chamber 31S. Vs* is a brake fluid amount in the secondary hydraulic chamber 31S when the master cylinder 3 is deactivated, and a brake fluid amount that can flow out from the secondary hydraulic chamber 31S when the control by the by-wire control unit 101 (hereinafter referred to the by-wire control) is performed and when the pressing force brake unit 102 is activated. Assume that Ls represents a stroke amount of the secondary piston 32S relative to the cylinder 30. Assume that Ls* represents Ls required to achieve a secondary piston required stroke amount, i.e., Vs*. More specifically, Ls* is a maximum stroke amount of the secondary piston 32S (relative to the cylinder 30).

Assume that Vss represents a maximum fluid amount that the stroke simulator 5 can absorb, i.e., an amount of the brake fluid that the positive-pressure chamber 511 can absorb. Vss is a brake fluid amount flowing into the positive pressure chamber 511 since the piston 52 is located at an initial position until being maximally stroked. A volume of the positive pressure chamber 511 can be regarded as zero when the piston 52 is located at the initial position. Therefore, Vss is a brake fluid amount in the positive pressure chamber 511 when the piston 52 is maximally stroked. Assume that Vf represents each of amounts of the brake fluid required to be supplied from the primary hydraulic chamber 31P to each of the wheel cylinders 8a and 8d of the P system and from the secondary hydraulic chamber 31S to each of the wheel cylinders 8b and 8c of the S system, respectively, to allow the target wheel cylinder pressures Pw* to be generated by the pressing force brake unit 102. When the failure has occurred during the by-wire control, the apparatus 1 acquires the braking force by activating the pressing force brake unit 102. Vf is a brake fluid amount required therefor. For example, if the apparatus 1 should generate a vehicle deceleration of 0.65 G when the pressing force F is 500N, a wheel cylinder pressure required to generate this deceleration of 0.65 G is set as the target wheel cylinder pressure (a pressing force brake target pressure at the time of the failure) Pw*. Vf can be set based on this pressure Pw* and a hydraulic pressure-hydraulic amount characteristic of the wheel cylinder 8. The amount of Vf may be changed between the P system side and the S system side when, for example, the front/rear split pipe configuration is employed.

Vp* is set so as to establish a relationship with Vf that satisfies the following equation (1).

(Equation 1)

Vp*≧Vf (1)

In the present embodiment, Vp* is set so as to establish a relationship satisfying the following equation (2).

(Equation 2)

Vp*=Vf (2)

In other words, the primary hydraulic chamber 31P has a volume corresponding to Vf. Further, the following equation (3) is established (A is the cross-sectional area of the piston 32).

(Equation 3)

Vp*=Lp*×A (3)

Therefore, Lp* and A are set so as to satisfy the above-described equation (2). For example, focusing on Lp*, the following equation (4) is established.

(Equation 4)

Lp*=Vp*/A (4)

From the above-described equations (2) and (4), the following equation (5) is established.

(Equation 5)

Lp*=Vf/A (5)

When the failure has occurred during the by-wire control, the apparatus 1 supplies the brake fluid amount Vf from the primary hydraulic chamber 31P into the wheel cylinders 8a and 8d of the P system by activating the pressing force brake unit 102. By this operation, the apparatus 1 acquires the braking force. Vf/A is a stroke amount of the primary piston 32P required therefor. Assuming that Lpf represents this stroke amount, the following equation (6) is established.

(Equation 6)

Lp*=Lpf (6)

Vs* is set so as to establish a relationship with Vss that satisfies the following equation (7).

(Equation 7)

Vs*>Vss (7)

More specifically, Vs* is set so as to establish a relationship with Vss and Vf that satisfies the following equation (8).

(Equation 8)

Vs*≧Vss+Vf (8)

In the present embodiment, Vs* is set so as to establish a relationship satisfying the following equation (9).

(Equation 9)

Vs*=Vss+Vf (9)

In other words, the secondary hydraulic chamber 31S has a volume corresponding to a sum of Vss and Vf. On the other hand, the following equation (10) is established.

(Equation 10)

Vs*=Ls*×A (10)

Therefore, Ls* and A are set so as to satisfy the above-described equations (9) and (10). For example, focusing on Ls*, the following equation (11) is established.

(Equation 11)

Ls*=Vs*/A (11)

From the above-described equations (9) and (11), Ls* can be set according to the following equation (12).

(Equation 12)

$$\begin{matrix}{Ls}^{*} = ( Vss + Vf ) \text{/} A \\ = Vss \text{/} A + Vf \text{/} A\end{matrix} \qquad ( 12 )$$

Vss/A is a stroke amount of the secondary piston 32S that is required to supply Vss to the positive pressure chamber 511 at the time of the by-wire control, and is a maximum stroke amount of the secondary piston 32S at the time of the by-wire control. Assuming that Lsn represents this stroke amount, the following equation (13) is established.

(Equation 13)

Lsn=Vss/A (13)

When the failure has occurred during the by-wire control, the apparatus 1 supplies the brake fluid amount Vf from the secondary hydraulic chamber 31S to the wheel cylinders 8b and 8c of the S system by activating the pressing force brake unit 102. By this operation, the apparatus 1 acquires the braking force. Vf/A is a stroke amount of the secondary piston 32P additionally required therefor. Assuming that Lsf represents this stroke amount, the following equation (14) is established.

(Equation 14)

Lsf=Vf/A (14)

From the above-describe equations (12), (13), and (14), the following equation (15) is established.

(Equation 15)

Ls*=Lsn+Lsf (15)

From the above-described equations (2) and (9), the following equation (16) is established.

(Equation 16)

Vs*>Vp* (16)

In other words, Vs* is larger than Vp* by an amount corresponding to Vss. From the above-described equations (4), (11), and (16), the following equation (17) is established.

(Equation 17)

Ls*>Lp* (17)

In other words, on the P system side, the first oil passage 11A is not connected to the stroke simulator 5, so that the required stroke amount of the piston 32 is smaller than that of the S system side by an amount corresponding thereto.

Assume that Sn represents a maximum stroke amount of the brake pedal 2 at the time of the by-wire control. Sn is a pedal stroke required to satisfy a predetermined pedal feeling at the time of the by-wire control, and is set to a predetermined constant value independent of the pedal ratio K. Vss is determined from Sn, K, and A by the following equation (18).

(Equation 18)

Vss=(Sn/K)×A (18)

In other words, Vss is a fluid amount flowing out from the secondary hydraulic chamber 31S to realize Sn, i.e., a fluid amount that the stroke simulator 5 is required to absorb, at the time of the by-wire control. The following equation (19) is established from the above-described equations (13) and (18).

(Equation 19)

Lsn=Sn/K (19)

When the failure has occurred during the by-wire control, the apparatus 1 acquires the braking force by activating the pressing force brake unit 102. Assume that Sf represents a stroke amount of the brake pedal 2 that is required additionally therefor. Assume that S* represents a maximum stroke amount of the brake pedal 2 among stroke amounts thereof not only at the time of the by-wire control but also when the pressing force brake unit 102 is activated with the failure occurred during the by-wire control. At this time, the following equation (20) is established.

(Equation 20)

S*=Sn+Sf (20)

S* should be set to a stroke amount that allows the whole Vs* to be discharged from the secondary hydraulic chamber 31S, and therefore is determined from Vs*, Vf, K, and A by the following equation (21).

(Equation 21)

S*≧(Vs*/A+Vf/A)×K (21)

From the above-described equation (11), Vs*/A corresponds to Ls*. From the above-described equation (5), Vf/A corresponds to Lp*. Therefore, the following equation (22) is established.

(Equation 22)

S*≧(Lp*+Ls*)×K (22)

In other words, a value acquired by multiplying a sum of Lp* and Ls* by K is a stroke amount (the required pedal stroke) of the brake pedal 2 that is required to realize the required stroke amounts Lp* and Ls* of the master cylinder pistons 32, and S* is set to this value or larger. In the present embodiment, S* is set so as to establish a relationship satisfying the following equation (23).

(Equation 23)

S*=(Lp*+Ls*)×K (23)

As indicated by the above-describe equation (9), Vs* is Vs*=Vss+Vf. Further, as indicated by the above-described equation (15), Ls* is Ls*=Lsn+Lsf. In other words, on the S system side, the first oil passage 11A is connected to the stroke simulator 5, which leads to a necessity of the fluid amount Vss (the piston stroke amount Lsn) capable of satisfying the predetermined pedal feeling during the by-wire control at normal times, in addition to the fluid amount Vf (the piston stroke amount Lsf) that allows the target wheel cylinder pressure Pw* to be generated by the pressing force brake unit 102 when the failure has occurred. As indicated by the above-described equation (2), Vp* is Vp*=Vf. Further, as indicated by the above-described equation (6), Lp* is Lp*=Lpf. In other words, on the P system side, the first oil passage 11A is not connected to the stroke simulator 5, so that the required fluid amount can be limited to only the fluid amount Vf (the piston stroke amount Lpf) that allows Pw* to be generated by the pressing force brake unit 102 when the failure has occurred. The following equation (24) is established by rewriting the above-described equation (23) with use of the above-describe equations (5) and (12).

(Equation 24)

$$\begin{matrix}{S}^{*} = ( Vss \text{/} A + Vf \text{/} A + Vf \text{/} A ) \times K \\ = ( Vss \text{/} A ) \times K + ( 2 Vf \text{/} A ) \times K\end{matrix} \qquad ( 24 )$$

Focusing on a first equation on a right side, Vss/A corresponds to Lsn from the above-described equation (13). From the above-described equation (14), one of Vf/As corresponds to Lsf. From the above-described equations (5) and (6), the other of Vf/As corresponds to Lpf. Focusing on a second equation on the right side, (Vss/A)×K corresponds to Sn from the above-described equation (18). Therefore, (2Vf/A)×K corresponds to Sf from the above-described equation (20). The following equation (25) is established from the above-described equations (5), (6), and (14).

(Equation 25)

Sf=(2Vf/A)×K=(Lsf+Lpf)×K (25)

2Vf/A or Lsf+Lpf is the stroke amounts of the master cylinder pistons 32 (the primary piston 32P and the secondary piston 32S) additionally required to acquire the braking force by the pressing force brake unit 102.

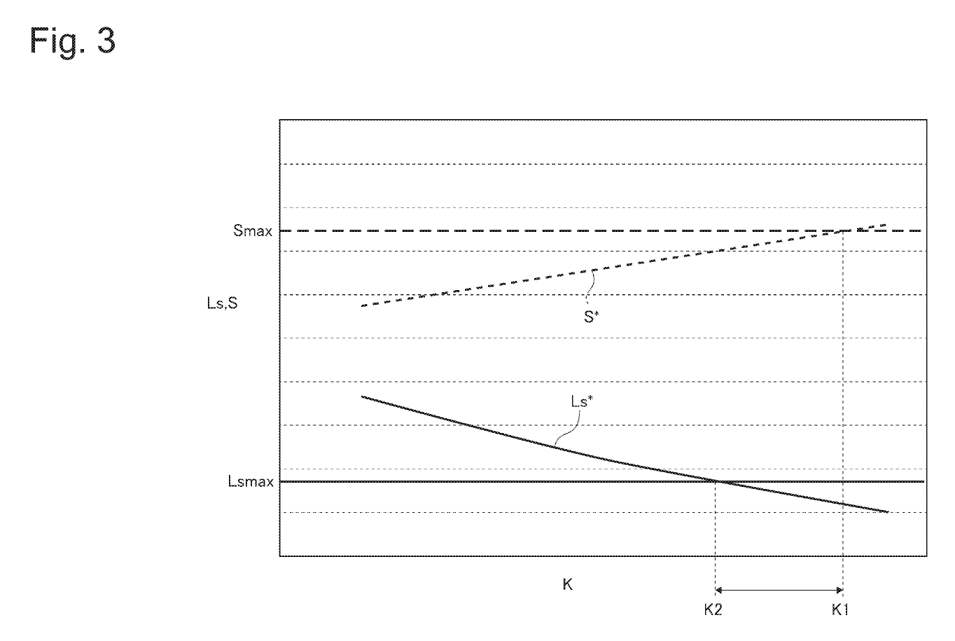

FIG. 3 illustrates a relationship of S* and Ls* with K. Assume that Smax represent a maximum value of the pedal stroke S based on a design thereof. Assume that Lsmax represents a maximum value of the stroke amount Ls of the secondary piston 32S based on a design thereof. Since K is K>1, Smax and Lsmax are Smax>Lsmax. Further, Smax is Smax≧S* and Lsmax is Lsmax≧Ls*. The following equation (26) is established from the above-described equations (20) and (25).

(Equation 26)

S*=Sn+(2Vf/A)×K (26)

In other words, supposing that Sn, Vf, and A have given values, S* changes according to K. S* is larger when K is high than when K is low. Supposing that K1 represents K when S* is S*=Smax, K should be K≦K1 due to the requirement of Smax≧S*. Further, the following equation (27) is established from the above-described equations (14), (15), and (19).

(Equation 27)

Ls*=Sn/K+Vf/A (27)

In other words, supposing that Sn, Vf, and A have given values, Ls* changes according to K. Ls* is smaller when K is high than when K is low. Supposing that K2 represents K when Ls* is Lsmax=Ls*, K should be K≧K2 due to the requirement of Lsmax≧Ls*. Therefore, K is established within a range of K2 to K1. K is set so as to satisfy K2≦K≦K1.

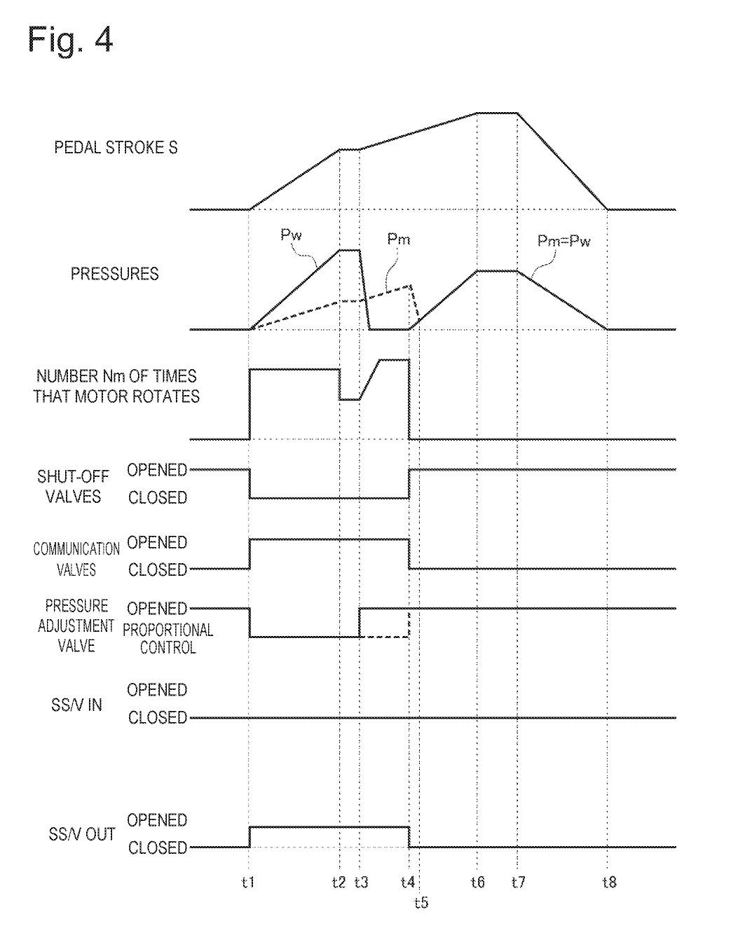

Next, a function will be described. FIG. 4 is a timing chart illustrating one example of changes in the pedal stroke S, each of the pressures, and the activation state of each of the actuators over time when the failure has occurred in one of the actuators (the pressure adjustment valve 27) during the by-wire control in the apparatus 1. At time t1, the driver starts the brake operation. From time t1 to time t2, the brake pedal 2 is pressed. During the brake operation, the ECU 100 performs the by-wire control by the by-wire control unit 101. More specifically, when the brake operation state detection unit 104 detects the brake operation, the wheel cylinder pressure control unit 106 controls the shut-off valves 21 in the valve-closing directions and controls the SS/V OUT 24 in the valve-opening direction. As a result, the brake fluid contained in the secondary hydraulic chamber 31S is supplied to the stroke simulator 5 (the positive pressure chamber 511). The stroke simulator 5 is activated, and the pedal stroke S is increased from zero. Further, the master cylinder pressures Pm (the pressures in the primary hydraulic chamber 31P and the secondary hydraulic chamber 31S) are increased according to an increase in a reaction force of the spring 53. On the other hand, the target wheel cylinder pressure calculation unit 105 calculates the target wheel cylinder pressure Pw*. To realize this Pw*, the wheel cylinder pressure control unit 106 activates the pump 7 (keeps the number Nm of times that the motor 7a rotates at a predetermined constant value), and controls the communication valves 26 in the valve-opening directions and proportionally controls the pressure adjustment valve 27 in the valve-closing direction. As a result, Pw is increased by a larger gradient than Pm according to the increase in S (the boosting control). After time t2, S and Pm are maintained until time t3. The wheel cylinder pressure control unit 106 keeps Nm at a predetermined constant value smaller than that during the increase in S. Pw is kept at a constant value.

In this state, the failure has occurred in the pressure adjustment valve 27 at time t3. Despite issue of the instruction for the valve-closing direction (the proportional control) to the pressure adjustment valve 27 as indicated by a broken line, the pressure adjustment valve 27 is actually activated in a valve-opening direction (stuck in the opened state) as indicated by a solid line. The brake fluid discharged from the pump 7 is undesirably discharged via the first pressure reduction oil passage 17. Therefore, after time t3, it become impossible to keep Pw at Pw* although the by-wire control continues. Even if the wheel cylinder pressure control unit 106 increases Nm, Pw is reduced to zero. According thereto, the driver further presses the brake pedal 2 with an attempt to increase the braking force. S and Pm are increased due to the activation of the stroke simulator 5.

At time t4, the fail-safe unit 103 detects the occurrence of the abnormality (the failure in the pressure adjustment valve 27), and switches the brake control from the by-wire control to the pressing force brake. In other words, a time period from time t3 to time t4 is a time period required to detect the abnormality. After time t4, the fail-safe unit 103 deactivates all of the actuators and activates the pressing force brake unit 102. The shut-off valves 21 are opened. The SS/V OUT 24 is closed. The communication valves 26 are closed. As a result, focusing on the P system, the brake fluid contained in the primary hydraulic chamber 31P is supplied to the wheel cylinders 8a and 8d of the P system via the first oil passage 11P according to the increase in the stroke amount Lp of the primary piston 32P (a reduction in the volume of the primary hydraulic chamber 31P). Focusing on the S system, Vs* is set to a larger amount than Vss as indicated by the above-described equation (7). Therefore, even if the stroke amount of the piston 52 of the stroke simulator 5 is maximized (is fully stroked) during the time period from time t3 to time t4, the secondary hydraulic chamber 31S still contains the brake fluid that can flow out therefrom. This brake fluid is supplied to the wheel cylinders 8b and 8c of the S system via the first oil passage 11S, without being supplied to the stroke simulator 5 (the positive pressure chamber 511), according to the increase in the stroke amount Ls of the secondary piston 32S (the reduction in the volume of the secondary hydraulic chamber 31S). Therefore, both the pressures in the wheel cylinders 8a and 8d, i.e., the wheel cylinder pressures Pw(P) of the P system, and the pressures in the wheel cylinders 8b and 8c, i.e., the wheel cylinder pressures Pw(S) of the S system are increased. Further, S is increased according to the increase in the stroke amount of the primary piston 32P relative to the cylinder 30. The pressures Pm (the pressures in the primary hydraulic chamber 31P and the secondary hydraulic chamber 31S) are temporarily reduced according to the outflow of the brake fluid from the hydraulic chamber 31 to the wheel cylinders 8, and reach Pw (Pw(P) and Pw(S) at time t15. After time t5, the pressures Pm are increased while having similar values to Pw.

Focusing on the P system, Vp* is set to Vf as indicated by the above-described equation (2). Therefore, the fluid amount that can be supplied from the primary hydraulic chamber 31P to the wheel cylinders 8a and 8d is Vf at time t4 regardless of the stroke amount of the piston 52 of the stroke simulator 5. Focusing on the S system, Vs* is set to Vss+Vf as indicated by the above-described equation (9). Therefore, even if the stroke amount of the piston 52 is maximized during the time period from time t3 to time t4, the fluid amount that can be supplied from the secondary hydraulic chamber 31S to the wheel cylinders 8b and 8c is the fluid amount Vf at time t4. Therefore, both Pw(P) and Pw(S) are increased after time t4, and Pw(P) and Pw(S) each reach the pressing force brake target pressure Pw* at the time of the failure, at time t6 when Lp and Ls reach Lp* and Ls*, respectively. After time t6, the brake fluid becomes unable to be supplied from the hydraulic chamber 31 to the wheel cylinders 8, according to which Pw(P) and Pw(S) are kept at Pw*. Further, the piston 32 becomes unable to be stroked more than that, according to which S is kept at the maximum stroke amount S* at the time of the failure. At time t7, the driver starts releasing the pressed brake pedal 2. According thereto, Pw(P) and Pw(S) start to be reduced while having similar values to Pm. After time t7, Pw(P) and Pw(S) are reduced while having similar values to each other, and are reduced to zero at time t8. In the above description, the changes at the time of the failure in the pressure adjustment valve 27 have been described as one example of the changes at the time of the abnormality, and these changes are basically similar even at the time of another kind of abnormality.

In this manner, the brake fluid contained in the primary hydraulic chamber 31P does not flow out to the first oil passage 11 (the volume of the primary hydraulic chamber 31P is not changed) with the driver performing the brake operation and the wheel cylinder pressures Pw generated by the by-wire control unit 101. The brake fluid contained in the secondary hydraulic chamber 31S flows out to the first oil passage 11A, and flows into the positive pressure chamber 511 of the stroke simulator 5 via the second oil passage 12 (the volume of the secondary hydraulic chamber 31S is reduced). The positive pressure chamber 511 absorbs the brake fluid from the secondary hydraulic chamber 31S, by which the stroke simulator 5 is activated to achieve the pedal feeling. When the abnormality (the failure) has occurred in this state and the brake control is switched from the by-wire control to the pressing force brake, the communication is established between the master cylinder 3 and the wheel cylinders 8, which allows the hydraulic pressures to be generated in the wheel cylinders 8 by the brake operation force input by the driver. By this operation, the required braking force is acquired. The brake fluid contained in the primary hydraulic chamber 31P flows into the wheel cylinders 8a and 8d via the first oil passage 11P. The brake fluid contained in the secondary hydraulic chamber 31S flows into the wheel cylinders 8b and 8c via the first oil passage 11S. At this time, the piston 52 of the stroke simulator 5 stays at or around a position when the brake control is switched from the by-wire control to the pressing force control, and the brake fluid delivered from the secondary hydraulic chamber 31S (at the time of the by-wire control) is stored inside the positive pressure chamber 511. Even when the driver attempts to generate the wheel cylinder pressures Pw (the braking forces) by pressing the brake pedal 2 in this state, the fluid amount that can be supplied from the secondary hydraulic chamber 31S to the wheel cylinders 8b and 8c is reduced by an amount as large as the above-described brake fluid already delivered in the positive pressure chamber 511 (an amount corresponding to the stroke of the piston 52). In other words, even if the driver presses the brake pedal 2 with an attempt to increase the pressures in the wheel cylinders 8 when the abnormality has occurred, the brake fluid amount usable to increase the pressures in the wheel cylinders 8 is reduced in the pipe system (the S system) including the stroke simulator 5 by the amount as large as the fluid amount absorbed by the positive pressure chamber 511 according to the amount of the brake operation performed so far. Therefore, a sufficient braking force may be unable to be acquired when the abnormality has occurred.

On the other hand, in the apparatus 1, the fluid amount Vs* that can be supplied from the secondary hydraulic chamber 31S (the brake fluid amount that can flow out from the secondary hydraulic chamber 31S at the time of the by-wire control and the pressing force brake) is set to a larger amount than Vss that the positive pressure chamber 511 can absorb (the brake fluid amount flowing into the positive pressure chamber 511 until the piston 52 is maximally stroked), as indicated by the above-described equation (7). This results in the brake fluid remaining in the secondary hydraulic chamber 31S even with the brake fluid maximally absorbed in the positive pressure chamber 511 (the piston 52 maximally stroked), when the abnormality has occurred with the driver performing the brake operation and the wheel cylinder pressures generated by the by-wire control. Therefore, the brake fluid can be supplied from the secondary hydraulic chamber 31S to the wheel cylinders 8b and 8c according to the driver's operation of pressing the brake pedal 2. In this manner, the apparatus 1 can acquire the sufficient braking force when the abnormality has occurred, by allowing the pressures in the wheel cylinders 8b and 8c to be increased by the master cylinder 3 even when the brake control is switched to the pressing force brake in the pipe system (the S system) including the stroke simulator 5.

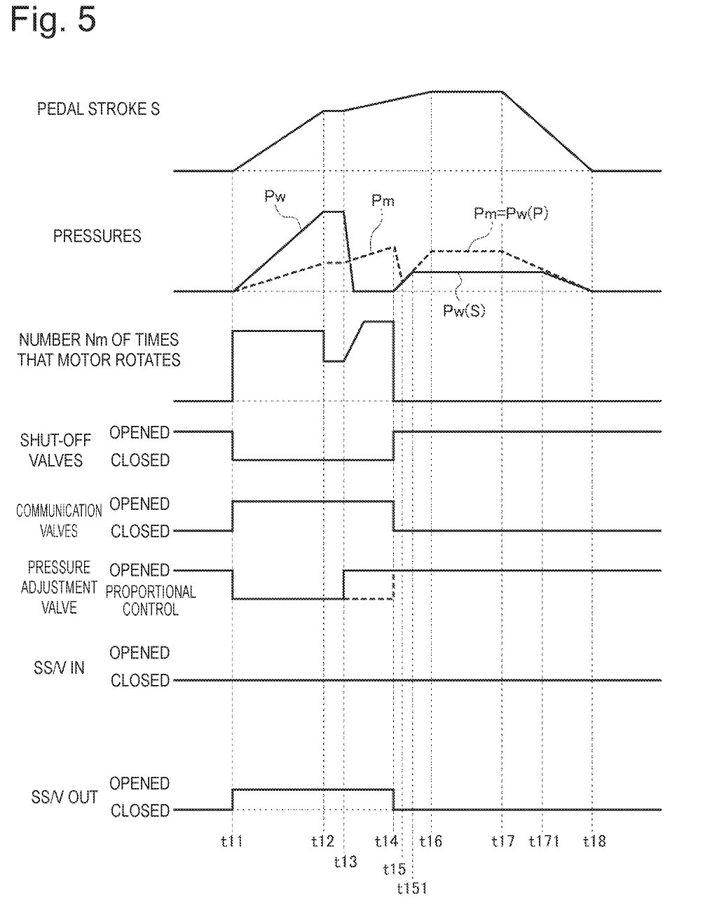

FIG. 5 is a timing chart illustrating a comparative example that is similar to FIG. 4. In the comparative example, Vp* is set to Vf. Further, Vs* is larger than Vss, and is set to a smaller amount than Vss+Vf. Other configurations are similar to the present embodiment. Times t11 to t15 are similar to times t1 to t5 illustrated in FIG. 4. In the comparative example, Vs* is set to the smaller amount than Vss+Vf. Therefore, when the stroke amount of the piston 52 of the stroke simulator 5 exceeds a predetermined value (for example, a value close to the maximum stroke amount) during a time period from time t13 to time t14, the fluid amount that can be supplied from the secondary hydraulic chamber 31S to the wheel cylinders 8b and 8c falls below Vf at time t14. Therefore, after time t14, Pw(S) is not increased to the pressing force brake target pressure Pw* at the time of the failure. At time t151, Pw(S) is increased to a predetermined value lower than Pw*, but the stroke amount of the secondary piston 32S is maximized (fully stroked), which makes it impossible to supply the brake fluid from the secondary hydraulic chamber 31S to the wheel cylinders 8b and 8c. Therefore, after time t151, Pw(S) is kept at this predetermined value despite the increase in S. On the other hand, Vp* is set to Vf. Therefore, at time t14, the fluid amount that can be supplied from the primary hydraulic chamber 31P to the wheel cylinders 8a and 8d is Vf. Accordingly, Pw(P) is increased after time t14, and is continuously increased even after time t151. At time t16 where Lp reaches Lp*, Pw(P) reaches the pressing force brake target pressure Pw* at the time of the failure. After time t16, the brake fluid becomes unable to be supplied from the primary hydraulic chamber 31P to the wheel cylinders 8a and 8d, according to which Pw(P) is kept at Pw*. After time t16, the primary piston 32P becomes unable to be stroked more than that, according to which S is maintained. At time t17, the driver starts releasing the pressed brake pedal 2. According thereto, Pw(P) starts to be reduced while having a similar value to the pressure in the primary hydraulic chamber 31P. At time t171, Pw(P) is reduced to Pw(S). After time t171, Pw(P) and Pw(S) are reduced while having similar values to each other, and are reduced to zero at time t18.

In this manner, according to the comparative example, when the brake control transitions from the by-wire control to the pressing force brake, in the pipe system (the S system) including the stroke simulator 5, the fluid amount that can be supplied from the secondary hydraulic chamber 31S to the wheel cylinders 8b and 8c is small because the stroke simulator 5 absorbs the brake fluid from the secondary hydraulic chamber 31S. Therefore, Pw(S) cannot be increased to Pw* by activating the master cylinder 3 with use of the pressing force F. In other words, the secondary piston 32S is undesirably quickly stroked to the maximum at the time of the pressing force brake, and only low Pw can be generated in the S system, so that the required braking force cannot be generated. Therefore, the sufficient braking force may be unable to be acquired when the abnormality has occurred.

On the other hand, in the apparatus 1, the fluid amount Vs* that can be supplied from the secondary hydraulic chamber 31S (of the S system including the stroke simulator 5) is set to the sum of the fluid amount Vf required to generate the target wheel cylinder pressures Pw* by the pressing force brake unit 102, and Vss, as indicated by the above-described equation (9). Therefore, even when the abnormality has occurred with the driver performing the brake operation and Pw generated by the by-wire control, the fluid amount Vf required to generate Pw* by the pressing force brake remains in the secondary hydraulic chamber 31S even if the positive pressure chamber 511 maximally absorbs the brake fluid. In other words, the fluid amount that allows the required braking force to be generated by the pressing force brake is secured in the master cylinder 3 even with the brake fluid consumed by the stroke simulator 5. Therefore, the apparatus 1 can generate Pw* by the braking force to acquire the sufficient braking force, when the abnormality has occurred. Therefore, the present embodiment eliminates the necessity of, for example, redundantly preparing the power system to continue the by-wire control to acquire the braking force when the abnormality has occurred. Therefore, the present embodiment can prevent or cut down increases in a size and cost of the apparatus 1. As indicated by the above-described equation (8), Vs* may be larger than the sum of Vf and Vss. In the present embodiment, Vs* is the sum of Vf and Vss. Therefore, the present embodiment prevents or cuts down an increase in the volume of the secondary hydraulic chamber 31S corresponding to Vs*, thereby preventing or cutting down an increase in the volume of the master cylinder 3 as a whole. As a result, the present embodiment can prevent or cut down an increase in a size of the master cylinder 3. Therefore, the present embodiment can prevent or cut down an increase in a size of the apparatus 1.

In the above-described comparative example, in the pipe system (the P system) not including the stoke simulator 5, Pw can be increased to the pressing force brake target pressure Pw* at the time of the failure. In the apparatus 1, the fluid amount Vp* that can be supplied from the primary hydraulic chamber 31P (of the P system not including the stroke simulator 5) is set to the fluid amount Vf required to generate the target wheel cylinder pressure Pw* by the pressing force brake unit 102. Therefore, the fluid amount Vf required to generate Pw* by the pressing force brake is contained in the primary hydraulic chamber 31P during the by-wire control. Accordingly, the apparatus 1 can generate Pw* by the pressing force brake when the abnormality has occurred in the P system, similarly to the above-described comparative example. Therefore, the apparatus 1 can acquire the sufficient braking force even when the abnormality has occurred. Vp* may be Vs* or larger. In the apparatus 1, Vp* is set to a smaller amount than Vs* as indicated by the above-described equation (16). Therefore, the present embodiment reduces the sum of Vp* and Vs*, i.e., a sum of the volumes of the individual hydraulic chambers 31P and 31S (respectively corresponding to Vp* and Vs*), and therefore prevents or cuts down the increase in the volume of the master cylinder 3 as a whole. In other words, the present embodiment can prevent or cut down the increase in the size of the master cylinder 3 by setting Vp* (the volume of the primary hydraulic chamber 31P corresponding thereto) to the smaller amount than Vs* in the case where Vs* (the volume of the secondary hydraulic chamber 31S corresponding thereto) is set in the above-described manner. Further, Vp* may be larger than Vf as indicated by the above-described equation (1). In the apparatus 1, Vp* is set to Vf as indicated by the above-described equation (2). Therefore, the volume of Vp* (the primary hydraulic chamber 31P corresponding thereto) is reduced to a minimum volume that can achieve the required fluid amount Vf. Therefore, the present embodiment can further effectively prevent or cut down the increase in the volume of the master cylinder 3 as a whole. The diameter (the cross-sectional area) of the primary hydraulic chamber 31P may be set to a smaller diameter than the diameter (the cross-sectional area) of the secondary hydraulic chamber 31S to set Vp* to the smaller amount than Vs*. In the apparatus 1, the maximum stroke amount Lp* of the primary piston 32P is set to a smaller amount than the maximum stroke amount Ls* of the secondary piston 32S as indicated by the above-described equation (17). Therefore, the diameters of the hydraulic chamber 31 and the piston 32 do not have to be changed between the P system and the S system, by which Vp* can be further easily set to a smaller amount than Vs*. More specifically, the primary piston 32P and the secondary piston 32S have the cross-sectional areas A equal to each other. Therefore, the piston 32 and the cylinder 30 can be further easily manufactured. Further, the present embodiment can prevent or cut down an increase in an axial length (a dimension in the x-axis direction) of the master cylinder 3 by setting Lp* to the smaller amount than Ls*. The present embodiment allows the piston 32 and the cylinder 30 to be further easily manufactured by preventing or cutting down the increase in the axial length.

More specifically, the pipe system including the stroke simulator 5 in the apparatus 1 is the S system. The pistons 32 of the master cylinder 3 are activated in response to the stroke S of the brake pedal 2. The primary piston 32P is activated according to the operation of the brake pedal 2. The secondary piston 32S defines the secondary hydraulic chamber 31S while defining the primary hydraulic chamber 31P together with the primary piston 32P. The primary hydraulic chamber 31P is connected to the wheel cylinders 8a and 8d via the first oil passage 11P to which the stroke simulator 5 is not connected. The secondary hydraulic chamber 31S is connected to the positive pressure chamber 511 of the stroke simulator 5 via the second oil passage 12. The secondary hydraulic chamber 31S is connected to the wheel cylinders 8b and 8c via the first oil passage 11S to which the stroke simulator 5 is connected. The pipe system including the stroke simulator 5 is not limited to the S system, and may be the P system. In this case, the above-provided description about the secondary hydraulic chamber 31S applies to the primary hydraulic chamber 31P.

As indicated by the above-described equation (18), Vss is set to the value acquired by multiplying Sn/K by A. In other words, the positive pressure chamber 511 of the stroke simulator 5 is provided so as to be able to absorb the fluid amount of (Sn/K)×A. Therefore, the fluid amount of (Sn/K)×A can flow out from the secondary hydraulic chamber 31S at the time of the by-wire control. In other words, the brake pedal 2 can be stroked by Sn. Therefore, the predetermined pedal feeling can be satisfied at the time of the by-wire control.

As indicated by the above-described equation (21), S* is set to the value acquired by multiplying the sum of Vs*/A and Vf/A by K. Now, Vs* is Vs*>Vss as indicated by the above-described equation (7). Setting S* in this manner contributes to achieving the stroke amount Vss/A of the secondary piston 32S required to supply Vss to the positive pressure chamber 511 at the time of the normal by-wire control, the stroke amount of the secondary piston 32S required to supply the brake fluid from the secondary hydraulic chamber 31S to the wheel cylinders 8b and 8c of the S system at the time of the pressing force brake after the abnormality has occurred, and the stroke amount Vf/A of the primary piston 32P required to supply the brake fluid Vf from the primary hydraulic chamber 31P to the wheel cylinders 8a and 8d of the P system. Therefore, the apparatus 1 can generate the braking force in the S system by the pressing force brake and generate the braking force required in the P system by the pressing force brake, even when the abnormality has occurred with the brake fluid maximally absorbed by the stroke simulator 5 during the by-wire control.

As indicated by the above-described equations (22) and (23), S* is set to the value (or a larger value) acquired by multiplying the sum of Lp* and Ls* by K. Setting S* in this manner contributes to realizing the required stroke amount Lp* of the primary piston 32P and the required stroke amount Ls* of the secondary piston 32S. For example, setting Lp* to Vf/A as indicated by the above-described equation (5) allows the braking force required in the P system to be generated by the pressing force brake even when the abnormality has occurred during the by-wire control. Setting Ls* to (Vss+Vf)/A as indicated by the above-described equation (12) allows the braking force required in the S system to be generated by the pressing force brake even when the abnormality has occurred with the brake fluid maximally absorbed by the stroke simulator 5 during the by-wire control.

### Other Embodiments

Having described an embodiment for implementing the present invention based on the exemplary embodiment thereof, the specific configuration of the present invention is not limited to the exemplary embodiment, and the present invention also includes a design modification and the like thereof made within a range that does not depart from the spirit of the present invention. For example, the brake apparatus (the brake system) to which the present invention is applied may be any brake apparatus including a mechanism (the stroke simulator) for simulating the reaction force of the brake operation and also capable of blocking the communication between the master cylinder and the wheel cylinder to increase the pressure in the wheel cylinder with use of a hydraulic source other than the master cylinder, and is not limited to the brake apparatus according to the exemplary embodiment. For example, the above-described hydraulic source is not limited to the pump, and may be an accumulator or the like. Further, the configurations of the hydraulic circuit and the actuators for controlling the wheel cylinder pressures, and the method for activating each of the actuators are not limited to them according to the exemplary embodiment, and can be changed as appropriate.

Having described several embodiments of the present invention, those skilled in the art will be able to easily appreciate that the embodiments described as the examples can be modified or improved in various manners without substantially departing from the novel teachings and advantages of the present invention. Therefore, such modified or improved embodiments are intended to be also contained in the technical scope of the present invention. The above-described embodiments may also be arbitrarily combined.

Having described the embodiments of the present invention, the above-described embodiments of the present invention are intended to only facilitate the understanding of the present invention, and are not intended to limit the present invention thereto. Needless to say, the present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2015-028366 filed on Feb. 17, 2015. The entire disclosure of Japanese Patent Application No. 2015-028366 filed on Feb. 17, 2015 including the specification, the claims, the drawings, and the abstract is incorporated herein by reference in its entirety. The entire disclosure of Japanese Patent Application Public Disclosure No. 2010-83411 (PTL1) including the specification, the claims, the drawings, and the abstract is incorporated herein by reference in its entirety.

### REFERENCE SIGN LIST

1 brake apparatus
2 brake pedal (brake operation member)
21 shut-off valve (valve)
3 master cylinder
31P primary hydraulic chamber (second chamber)
31S secondary hydraulic chamber (first chamber)
32P primary piston
32S secondary piston
5 stroke simulator
52 piston
511 positive pressure chamber
7 pump (hydraulic source)
8 wheel cylinder
11 first oil passage (oil passage)
12 second oil passage (branch oil passage)
101 by-wire control unit
102 pressing force brake unit

1.-17. (canceled)

18. A brake apparatus comprising:
an oil passage connecting a master cylinder and a wheel cylinder therebetween;
a valve configured to switch a communication state of the oil passage;
a by-wire control unit configured to close the valve to increase a pressure in the wheel cylinder by a hydraulic source provided separately from the master cylinder, according to a state of a brake operation performed by a driver;
a pressing force brake unit configured to open the valve to increase the pressure in the wheel cylinder by the master cylinder; and
a stroke simulator connected to a portion of the oil passage between the master cylinder and the valve, and configured to generate a brake operation reaction force due to an increase and a reduction in a volume of a positive pressure chamber formed inside the stroke simulator,
wherein brake fluid contained in a first chamber of the master cylinder flows into the positive pressure chamber at the time of control by the by-wire control unit, and
wherein a fluid amount that can be supplied from the first chamber is larger than a fluid amount that a positive pressure chamber can absorb therein.

19. The brake apparatus according to claim 18, wherein the fluid amount that can be supplied from the first chamber is equal to or larger than a sum of the fluid amount that the positive pressure chamber can absorb therein and a fluid amount required to generate a target wheel cylinder pressure by the pressing force brake unit.

20. The brake apparatus according to claim 18, wherein the master cylinder includes a second chamber partitioned off from the first chamber and connected to the wheel cylinder via the oil passage to which the stroke simulator is not connected, and
wherein a fluid amount that can be supplied from the second chamber is smaller than the fluid amount that can be supplied from the first chamber.

21. The brake apparatus according to claim 20, wherein the fluid amount that can be supplied from the second chamber is a fluid amount required to generate a target wheel cylinder pressure by the pressing force brake unit.

22. The brake apparatus according to claim 18, wherein the master cylinder is activated in response to a stroke of a brake operation member, and
wherein a maximum stroke amount of the brake operation member, among stoke amounts including a stroke amount when the pressing force brake unit is activated, is set to a value acquired by multiplying, by a predetermined ratio, a sum of a value resulting from dividing the fluid amount that can be supplied from the first chamber by a cross-sectional area of the master cylinder, and a value resulting from dividing a fluid amount required to generate a target wheel cylinder pressure by the pressing force brake unit by the cross-sectional area of the master cylinder.

23. The brake apparatus according to claim 18, wherein the master cylinder is activated in response to a stroke of a brake operation member, and
wherein the fluid amount that the positive pressure chamber can absorb therein is a value acquired by multiplying, by a cross-sectional area of the master cylinder, a value resulting from dividing a maximum stroke amount of the brake operation member at the time of the control by the by-wire control unit by a predetermined ratio.

24. The brake apparatus according to claim 18, wherein the master cylinder is activated in response to a stroke of a stroke operation member, and includes a primary piston configured to be activated according to an operation of the brake operation member, and a secondary piston defining the first chamber while defining, together with the primary piston, a second chamber connected to the wheel cylinder via the oil passage to which the stroke simulator is not connected, and
wherein a maximum stroke amount of the brake operation member, among stoke amounts including a stroke amount when the pressing force brake unit is activated, is set to a value equal to or larger than a value acquired by multiplying, by a predetermined ratio, a sum of a required stroke amount of the primary piston and a required stroke amount of the secondary piston.

25. The brake apparatus according to claim 24, wherein the primary piston and the secondary piston have cross-sectional areas equal to each other,
wherein the required stroke amount of the primary piston is a value acquired by dividing a fluid amount required to generate a target wheel cylinder pressure by the pressing force brake unit by the cross-sectional area of the primary piston or the secondary piston, and
wherein the required stroke amount of the secondary piston is a value acquired by dividing a sum of the fluid amount that the positive pressure chamber can absorb therein and the fluid amount required to generate the target wheel cylinder pressure by the pressing force brake unit by the cross-sectional area of the primary piston or the secondary piston.

26. The brake apparatus according to claim 25, wherein the fluid amount that the positive pressure chamber can absorb therein is a value acquired by multiplying, by the cross-sectional area of the primary piston or the secondary piston, a value resulting from dividing the maximum stroke amount of the brake operation member at the time of the control by the by-wire control unit by a predetermined ratio.

27. The brake apparatus according to claim 18, wherein the master cylinder is activated in response to a stroke of a stroke operation member, and includes a primary piston configured to be activated according to an operation of the brake operation member, and a secondary piston defining the first chamber while defining, together with the primary piston, a second chamber connected to the wheel cylinder via the oil passage to which the stroke simulator is not connected.

28. A brake apparatus comprising:
an oil passage connecting a master cylinder and a wheel cylinder therebetween;
a valve configured to switch a communication state of the oil passage;
a by-wire control unit configured to close the valve to increase a pressure in the wheel cylinder by a hydraulic source provided separately from the master cylinder according to a state of a brake operation performed by a driver;
a pressing force brake unit configured to open the valve to increase the pressure in the wheel cylinder by the master cylinder; and
a stroke simulator connected to a portion of the oil passage between a first chamber of the master cylinder and the valve and including a piston therein, the stroke simulator being configured to generate a brake operation reaction force due to an increase and a reduction in a volume of a positive pressure chamber according to activation of the piston in an axial direction,
wherein a brake fluid amount that can flow out from the first chamber at the time of control by the by-wire control unit is set to a larger amount than a brake fluid amount flowing into the positive pressure chamber until the piston is maximally stroked.

29. The brake apparatus according to claim 28, wherein the master cylinder includes a second chamber partitioned off from the first chamber and connected to the wheel cylinder via the oil passage to which the stroke simulator is not connected, and
wherein a fluid amount that can be supplied from the second chamber is smaller than a fluid amount that can be supplied from the first chamber.

30. The brake apparatus according to claim 28, wherein the fluid amount that can be supplied from the first chamber is equal to or larger than a sum of a fluid amount that the positive pressure chamber can absorb therein and a fluid amount required to generate a target wheel cylinder pressure by the pressing force brake unit.

31. The brake apparatus according to claim 30, wherein the master cylinder includes a second chamber partitioned off from the first chamber and connected to the wheel cylinder via the oil passage to which the stroke simulator is not connected, and
wherein a fluid amount that can be supplied from the second chamber is a fluid amount required to generate a target wheel cylinder pressure by the pressing force brake unit.

32. A brake apparatus comprising:
a master cylinder including a first chamber connected to a first pipe system;
a stroke simulator provided in a branch oil passage branching off from an oil passage connecting the first chamber and a wheel cylinder therebetween, and configured in such a manner that a piston dividing an inside of the stroke simulator is activated and a volume of a positive pressure chamber inside the stroke simulator is increased or reduced due to an inflow of brake fluid thereto;
a by-wire control unit configured to close a valve provided in the oil passage to increase a pressure in the wheel cylinder by a pump provided separately from the master cylinder according to a state of a brake operation performed by a driver; and
a pressing force brake unit configured to open the valve to increase the pressure in the wheel cylinder by the master cylinder,
wherein a brake fluid amount in the first chamber when the master cylinder is deactivated is larger than a brake fluid amount in the positive pressure chamber when the piston is maximally stroked.

33. The brake apparatus according to claim 32, wherein the master cylinder is activated in response to a stroke of a stroke operation member, and includes a primary piston configured to be activated according to an operation of the brake operation member, and a secondary piston defining, together with the primary piston, the first chamber while defining a second chamber connected to the wheel cylinder via the oil passage to which the stroke simulator is not connected.

34. The brake apparatus according to claim 33, wherein a fluid amount that can be supplied from the second chamber is smaller than a fluid amount that can be supplied from the first chamber.
